(19) United States
(12) Patent Application Publication
(10) Pub. No.: US 2019/0080426 A1
(43) Pub. Date: Mar. 14, 2019

(54) SYSTEMS AND METHODS TO FACILITATE REAL ESTATE TRANSACTIONS

(71) Applicant: Homesway Inc., Spring, TX (US)

(72) Inventor: Sheri Jennings, Spring, TX (US)

(21) Appl. No.: 16/132,203

(22) Filed: Sep. 14, 2018

Related U.S. Application Data
(60) Provisional application No. 62/558,497, filed on Sep. 14, 2017.

(51) Int. Cl. G06Q 50/16; G06Q 30/06; G06Q 30/02; G06F 3/01; G06F 3/0488

(52) U.S. Cl. CPC G06Q 50/16; G06Q 30/0631; G06Q 30/0206; G06F 3/04883; G06Q 30/0619; G06F 3/017; G06Q 30/0256

(57) ABSTRACT

The disclosed embodiments include systems and methods to facilitate a real estate transaction. In one of such embodiments, the method includes receiving a first feedback from a first electronic device of a first member of a buyer's team while the first electronic device is within a threshold distance of a property, the first feedback relating to a first feature of a plurality of features of the property. The method also includes determining, based on the first feedback, a recommendation to a listing team member belonging to a listing team that listed the property. The method further includes providing the first feedback and the recommendation to the listing team member.

### BACKGROUND

The present disclosure relates generally to systems and methods to facilitate real estate transactions. Home buyers and home owners typically enlist agents to assist them in purchasing and selling real estate properties, respectively. Sellers and their agents often engage with buyers and their agents to gauge the buyers' interests. However, this process is time consuming, and sellers and their agents may not have sufficient time to engage every perspective buyer or their agents before making a decision on whether to sell their properties. Further, certain buyers may be hesitant to provide their feedback directly to the sellers or their agents.

### BRIEF DESCRIPTION OF THE DRAWINGS

Illustrative embodiments of the present invention are described in detail below with reference to the attached drawing Figures, which are incorporated by reference herein, and wherein:

FIG. 1 is a network environment for facilitating real estate transactions in accordance with one embodiment.

FIGS. 2A-2D illustrate example user interfaces a buyers team member interacts with to select one or more features of a property in accordance with one embodiment.

FIGS. 3A and 3B illustrate example user interfaces a listing team member interacts with to select one or more features of a property to be listed or is currently listed by the listing team member in accordance with one embodiment.

FIGS. 4A-4I illustrate example user interfaces the buyer's team member interacts with to provide feedback on the property in accordance with one embodiment.

FIGS. 5A-5C illustrate example user interfaces the listing team member interacts with to review feedback from the buyer's team member.

The illustrated figures are only exemplary and are not intended to assert or imply any limitation with regard to the environment, architecture, design, or process in which different embodiments may be implemented.

### DETAILED DESCRIPTION

In the following detailed description of the illustrative embodiments, reference is made to the accompanying drawings that form a part hereof. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the embodiments described herein, the description may omit certain information known to those skilled in the art. The following detailed description is, therefore, not to be taken in a limiting sense, and the scope of the illustrative embodiments is defined only by the appended claims.

The present disclosure relates to systems and methods to facilitate real estate transactions. More particularly, the present disclosure relates to a real estate recommendation system that provides a member of a buyer's team with options to provide personalized feedback on a property the member is viewing in person or has recently viewed in person. The system shares the feedback with other members of the buyer's team as well as members of a listing team that listed the property to facilitate a real estate transaction between the members of the buyer's team and listing team. As defined herein, a real estate transaction involves any type of financial transaction related to a property. Examples of different types of real estate transactions include, but are not limited to purchasing or selling a property, renting a property, and renovating a property. As defined herein, a property includes a parcel of land, buildings on the parcel of land, and resources on or under the parcel land. A feature of a property includes any physical or intangible aspect of the property, such as, but not limited to, the size of the property, the layout of the property, the size of the lot (dimension and size) the property is built on, rooms (such as bedrooms, bathrooms, living rooms, kitchens, dining rooms, utility rooms) of the property, room dimensions, flooring types (such as carpet, hardwood, engineered wood, and vinyl), fixtures (such as cabinetry, fireplace, built-in vanities, built-in closets, lighting fixtures, as well as other physical properties that are permanently attached to the property), chattels (such as appliances, furniture, as well as other personal property not permanently attached to the property), garage (size and type), pool (such as size, shape, indoor vs outdoor, and type), amenities (such as privilege to enroll within a specific school district), as well as other quantifiable aspects of the property.

Further, a buyer's team (“buyers team”) is a team formed from one or more members (“buyers team member(s)”) seeking to purchase or rent a property. Examples of buyer's team members include individuals seeking to purchase or rent a property, real estate agents, bankers, attorneys, consultants, mortgage agents, financing sources, and other representatives of such individuals. A listing team is a team formed from one or more members (“listing team member(s)”) seeking to sell or rent out a property. Examples of listing team members include the property's owners as well as the owners' real estate agents, bankers, attorneys, consultants, mortgage agents, financing sources, and other representatives of the owners.

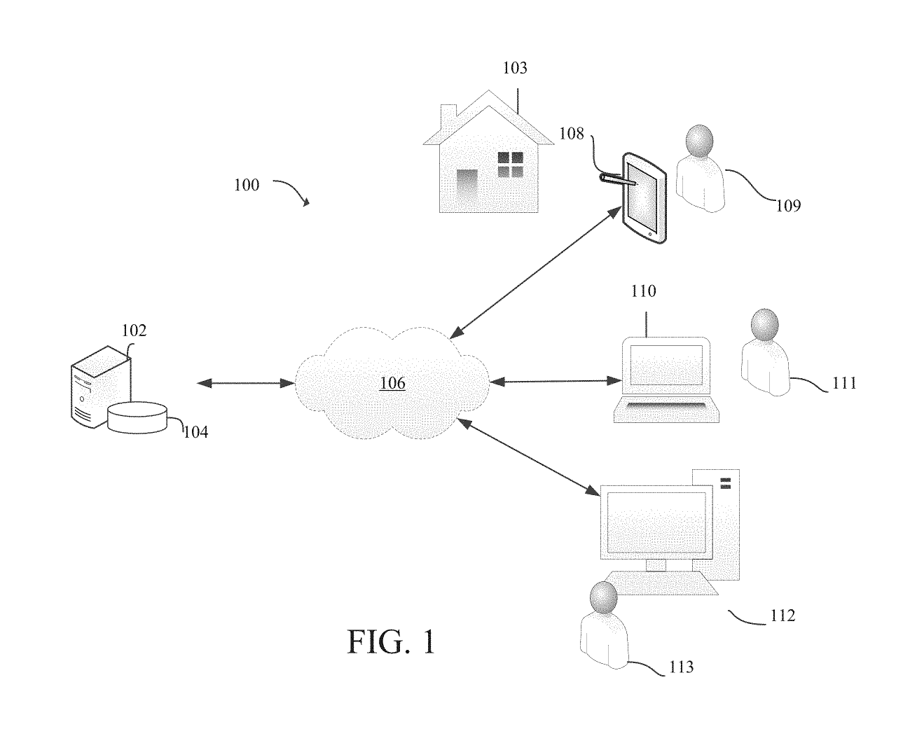

The system includes or is communicatively connected to a storage medium that contains properties of listing teams within a geographic region (such as a city, a neighborhood within a city, or a zip code address), feedback on different features of the properties, and contact information of buyers team members, listing team members, and third-party providers. As defined herein, third-party providers include any entity or individual that provides goods or services that facilitate a real estate transaction between listing team members and buyer's team members. Examples of third-party providers include home improvement companies, general contractors, sub-contractors, handymen, as well other individuals and entities that provide home improvement related goods and services. The system is also communicatively connected to applications running on electronic devices of buyer's team members, listing team members, and third-party providers. These applications provide user interfaces, through which, different buyers team members, listing team members, and third-party providers connect to and communicate with each other. Further the applications provide customizable dashboards for display on the electronic devices of buyers team members, listing team members, and third-party providers. For example, when the application first runs on a buyer's team member's electronic device, the application displays multiple bubble-shaped affordances on the electronic device, where each bubble-shaped affordance is associated with a feature of the property. As defined herein, an affordance refers to a user-interactive graphical user interface object that is displayed on the display screen of electronic devices, such as the first, second, and third electronic device 108, 110, and 112 of FIG. 1. For example, an image, a button, an interactive bubble, and text (e.g., hyperlink) each optionally constitute an affordance.

The buyer's team member interacts with the affordances to select one or more features (such as carport, garage, hardwood floor, two-story home, basement, or other features of the property) the buyers team member prefers or requires (collectively referred to as “desired features”). For example, the buyers team member may “drag and drop” a bubble affordance associated with a “two-car garage” feature to a region of the display screen where desired features are displayed. The buyer's team member may continue to “drag and drop” bubble affordances indicative of desired features until the buyer's team member has selected all of the desired features. The system accesses the application to determine which features are desired by the buyers team member, traverses the storage medium to determine properties that match some or all of the desired features (“matching properties”), and provides a list of matching properties for display on the electronic device of the buyers team member. The buyers team member may then select one or more properties from the list of matching properties to obtain additional information about the one or more properties, view additional features of the properties, share the properties (or the list of matching properties) with other buyers team members, schedule times to view the properties in person, and to perform other operations described herein.

In some embodiments, buyer's team members are locked out of certain features of a property displayed on the application until the buyer's team members are within a geographic range of the property (or has been within the geographic range within a threshold period of time) or within a particular room or location of the property. In one of such embodiments, a buyer's team member is locked out of features that allow such members to provide feedback on the property (or features of the property) unless the buyer's team member is at the property or in such room or location. In such embodiments, the application is operable to determine a current location of the buyer's team member, and to determine, based on the current location of the buyer's team member, whether such member is at the property. In another one of such embodiments, the application determines whether the buyer's team member has been to the property within a threshold period of time (such as within the last hour, the last day, or another quantifiable period of time), and locks the buyer's team member out of certain features of the application (such as feedback interfaces or affordances which the buyer's team member interacts with to provide feedback on the property) if the buyer's team member has not been at the property within the threshold period of time. The application, by locking out buyer's team members who are not physically present at the property from accessing review options, protects the integrity and accuracy of feedback provided by the buyer's team members.

The application, upon determining that the buyer's team member is at the location of the property, unlocks one or more feedback interfaces and affordances, the buyer's team member interacts with to provide feedback on the property or features of the property. In one embodiment bubble affordances are displayed based on the location of a buyer's team member within a property. Such location may be obtained using a global positioning system, a local wireless network accessed by the application, or using proximity and direction calculations derived from sensors deployed in the residence. For example, if a member has been determined to enter a kitchen of a property, pre-populated or currently determined features of the property may be selectable using the aforementioned bubble affordance. In one embodiment, a virtual or augmented reality two or three dimensional image of the property may be utilized to allow a member to select a feature such as a kitchen countertop shown in the image. Such image may be previously stored by the application, automatically generated by a device of the member via a camera or other image capturing device, or made available over a network by the listing team. In one embodiment, image recognition software is utilized to identify the feature by a feature type, composition, visual characteristics, manufacturer, color, size, dimensions, state of repair, or any other suitable data recognized with respect to the feature. Such image recognition system can be used in advance prior to the buyer team member's visit to the property or in real time as the buyer team member views the property. Upon selection of the countertop or other feature, a bubble affordance is generated and the member can drag the bubble affordance to a portion of a user interface associated with: positive or negative feedback, a desired remodeling effort, ranking the countertop relative to the countertops of other viewed properties, or allowing the member to provide further comments delivered through a voice, text, graphical, or other interface. In another embodiment, the application is operable to superimpose an image over, or replace, a portion of the image. For example, if the member indicates that the member does not like a particular feature of a room of a property such as a countertop of a kitchen, the application may display an image to the member that shows the room with the disliked feature replaced with one or more alternative features, such as replacing a wooden countertop with granite or marble, or allowing the member to select among several different countertops of various colors and materials. The application may even display pricing and purchase information for the replacement feature, or recommend contractors to install the feature or to receive bids from to install the feature.

Alternatively, different types of feedback interfaces and feedback affordances may be utilized. Examples of different types of feedback interfaces and feedback affordances include comment sections, ranking features that rank the property or rank a feature of the property, affordances indicative of the buyer's team member's preferences, sliding scales indicative of how much the buyer's team member likes or dislikes the property or certain features of the property, as well as other types of feedback interfaces and feedback affordances, which the buyer's team member interacts with to provide feedback on the property or features of the property.

A buyer's team member, while touring the property, may also compare the property with other desired properties (and compare features of the property with similar or identical features of other desired properties). For example, the application provides a feedback interface that simultaneously displays an “outdoor pool” feature of the property along with several similar pool features of other desired properties. The buyer's team member interacts with the feedback interface to review an outdoor pool of the property, compare the outdoor pool with pools of other desired properties, rank the desired properties based on the pool feature of the property, and solicit opinions of the outdoor pool feature or the property from other buyer's team members.

The system analyzes the feedback from the buyer's team member to determine one or more matching properties that match some or all of the buyer's team member's preferences, and transmits notifications to members of listing teams of the matching properties to notify the members of the listing teams that the buyer's team member may be interested in their properties. In some embodiments, the system provides members of listing teams of matching properties with the buyer's team member's feedback on the property.

In some embodiments, the system assesses the feedback of the buyer's team member, generates one or more recommendations to the listing team members based on the feedback, and provide the recommendations for display on the electronic devices of the buyer's team members. For example, the system, upon determining that multiple buyer's team members belonging to different buyer's teams have indicated a preference for hardwood floors in the living room of the property, transmits a recommendation to replace existing carpet in the living room with hardwood floors to members of the listing team. Additionally, the system may be used to communicate a listing team member's willingness to issue an allowance or discount the purchase price of the property in an amount equal to the cost to replace such carpet with hardwood floors. In some embodiments, the system also connects the listing team members with third-party providers to address the feedback or the recommendation. For example, the system, upon determining that a buyer's team member prefers hardwood floors, is operable to recommend to the listing team members to replace carpet floors with hardwood floors. The system is also operable to provide the contact information of several hardwood floor contractors to the listing team members. In one of such embodiments, the system is further operable to contact each hardwood floor contractor, obtain a quote from each respective hardwood floor contractor to replace the carpet with hardwood floors, and provide the listing team members with the contractors' contact information and quotes.

In some embodiments, the system aggregates data indicative of feedback received from multiple different buyer's team members (belonging to one or more buyer's teams) to determine an overall feedback (“aggregate feedback”) of the aggregate buyer's team members. In one of such embodiments, feedback of the property from different buyer's team members are aggregated. For example, if ten different buyer's team members have received the property and eight out of ten members commented that they prefer hardwood floors instead of carpet while two members commented that they prefer existing carpet, then the system is operable to generate an aggregate feedback that the buyer's team members prefer hardwood floor. In another one of such embodiments, feedback of different properties within a geographic region (which may be predefined, manually adjusted, or dynamically adjusted) are aggregated to determine an aggregate feedback of different buyer's team members. For example, if the kitchen of a property (within a geographic region) has outdated cabinetry, and ten buyer's team members who viewed different properties within the geographic region within a threshold time period (such as a day, a week, a month, or another quantifiable time period) indicated that they like “modern kitchens,” then the system is operable to generate an aggregate feedback that the ten buyer's team members prefer modern cabinetries (or modern kitchens).

In some embodiments, the system is also operable to filter the feedback based on one or more parameters to tailor the aggregate feedback. In such embodiments, the system is further operable to assign different weight to different parameters to tailor the aggregate feedback. Examples of such parameters include, but are not limited to household income, marital status, household size, age, as well as other tangible or intangible characteristics of the buyer's team members. Continuing with the foregoing examples, where the property is listed at $1,000,000, feedback regarding the floor covering from buyer's team members with a household income greater than or equal to a first threshold value is worth more than feedback from buyer's team members with a household income less than the first threshold value. Similarly, the system ignores feedback from buyer's team members with net worth less than a second threshold value (where the second threshold value is less than the first threshold value). Assuming that the household income of seven out of eight buyer's team members who commented that they prefer hardwood floor is less than the second threshold, and where the household income of both of the buyer's team members who commented that they prefer the existing carpet is greater than the first threshold, the system ignores the seven feedbacks from buyer's team members with household income less than the first threshold, and assigns greater weight to comments from the two buyer's team members who prefer existing carpet. Based on the foregoing weight system, the system would generate an aggregate feedback that the buyer's team members prefer hardwood flooring. Although the system in the foregoing embodiments rank and filter feedback based on parameters, in some embodiments, the system is operable to provide each feedback to the listing team members.

In some embodiments, the system also generates recommendations to address the aggregate feedback on a property and provides such recommendations to the listing team members that listed the property. Continuing with the foregoing examples, where the system has determined that overall, buyer's team members who viewed the property prefer hardwood floor, the system is operable to recommend the listing team members to perform a variety of tasks (such as, but not limited to, replacing existing carpet with hardwood floor or lowering the listing price of the property). Similarly, where the system has determined that overall, buyer's team members who viewed different properties within the geographic region of the property prefer modern kitchens, the system is operable to generate a variety of recommendations such as, but not limited to, replacing the existing cabinetry, adding new lighting features, replacing existing kitchen appliances with modern kitchen appliances, and lowing the listing price of the property.

As described and illustrated herein, the system provides the recommendations to the listing team members that listed the property. In some embodiments, the system, in response to receiving a feedback from a buyer's team member determines one or more additional properties within the geographic region that address the feedback, generate a recommendation to view the one or more additional properties, and provides the recommendation to the buyer's team member. For example, where the property has an outdoor pool, the system, in response to determining that the buyer's team member commented that the property does not have an indoor pool, searches similar properties (such as properties with similar features as the property) that have an indoor pool, generates a list of similar properties with indoor pools, and provides the list of similar properties for display on an electronic device of the buyer's team member together with a recommendation to view one or more of the listed properties. In other embodiments, the system is operable to dynamically determine, based on information about the buyer's team member (such as, preexisting information entered by the buyer's team member, information obtained from the buyer's team member's feedback, and information obtained from one or more applications running on the buyer's team member's electronic device), similar properties that buyer's team member may be interested in, generate a listing of the similar properties, and provide a recommendation to view one or more of the similar properties to the buyer's team member. For example, the system, in response to determining that the buyer's team member has young children, dynamically searches for properties within the geographic region that are not facing busy streets, have secure backyards, and have fenced in swimming pools, generates a list of properties with the foregoing features, and transmits a recommendation to view one or more of the list of properties to the buyer's team member. In one of such embodiments, the system dynamically performs the foregoing operations. In other embodiments, the buyer's team member may disable the system from dynamically performing the foregoing operations or set parameters for performing the foregoing operations.

In some embodiments, the system performs quantitative assessments of properties within the geographic region and generates recommendations based on the quantitative assessments. Examples of different quantitative assessments include, but are not limited to the average listing price, average square footage, average listing price per square foot, average lot size, average sales price, average views (including average views at different price ranges), average time on market (including average time at different price ranges, price per square foot), as well as other quantifiable metrics. For example, the system in response to determining that a listing team member intends to list a property at a first value, performs a quantitative analysis of the average time similar properties listed within different price ranges remain on the market, and provides a recommended listing price range to the listing team member.

In some embodiments, the system also provides targeted advertisements of properties containing desired features (as defined herein) to the buyer's team member. For example, the system, in response to determining that the buyer's team member has school aged children, generates a listing of properties within an acclaimed school district together with a recommendation that highlights that the properties are located within the boundaries of the acclaimed school district. In other embodiments the targeted advertisements include pictures, videos, and other types of content to highlight the desired features.

In some embodiments, the system, upon assessing the buyer's team member's feedback, searches for additional matching properties, contacts members of other listing teams associated with the additional matching properties, and recommends the other listing team members to contact the buyer's team member. For example, the system, upon determining that the buyer's team member did not like a property because it lacks an outdoor pool and a three-car garage, searches for homes within a geographic region with outdoor pools and three-car garages, and recommends members of listing teams that have properties with an outdoor pool and a three-car garage to contact the buyer's team member. As such, the system is operable to connect buyer's team members, listing team members, and third-party providers within a geographic region to facilitate buying, renting, selling, and renovating properties within the geographic region.

FIG. 1 is a network environment 100 for recommending real estate properties in accordance with one embodiment. The network environment 100 includes a real estate recommendation system 102 that is communicatively connected to a first electronic device 108 operated by a buyer's team member 109, a second electronic device 110 operated by a listing team member 111 who listed first property 103, and a third electronic device 112 operated by a third-party provider 113 via network 106. Examples of the first, second, and third electronic devices 108, 110, and 112 include laptop computers, tablet computers, smartphones, smart watches, PDAs, server systems, as well as similar electronic devices having hardware and software components operable to provide real estate properties for display on the respective electronic devices. Examples of the real estate recommendation system 102 include work management stations, server systems, desktop computers, laptop computers, tablet computers, smartphones, smart watches, PDAs, as well as similar electronic devices having a processor operable to receive feedback from buyer's team members and to provide the feedback to listing team members.

The storage medium 104 may be formed from data storage components such as, but not limited to, read-only memory (ROM), random access memory (RAM), flash memory, magnetic hard drives, solid state hard drives, CD-ROM drives, DVD drives, floppy disk drives, as well as other types of data storage components and devices. In some embodiments, the storage medium 104 includes multiple data storage devices. In further embodiments, the multiple data storage devices may be physically stored at different locations. In one of such embodiments, the data storage devices are components of a server station, such as a cloud server. In another one of such embodiments, the data storage devices are components of the real estate recommendation system 102. The storage medium 104 contains a database of properties of a geographic region (such as a city, a state, a country, or another quantifiable geographic region). The storage medium 104 also contains contact information of buyer's team members, listing team members, and third-party providers. Further, the storage medium 104 also includes instructions, which when executed by a processor of the real estate recommendation system 102, causes the real estate recommendation system 102 to analyze feedback from the first electronic device 108, generate a recommendation based on the feedback, and provide the feedback and recommendation for display on the second electronic device 110, as well as other operations described herein.

The buyer's team member 109 accesses properties within a geographic region via an application running on the first electronic device 108. More particularly, the application provides an interface the buyer's team member 109 interacts with to view one or more properties within the geographic region, as well as features of such properties. As discussed herein, the application provides user interfaces the buyer's team member 109 interacts with to select desired features of a property (such as by interacting with bubble-shaped affordances displayed on the user interface of the application). The first electronic device 108 then transmits data indicative of the desired features to the real estate recommendation system 102 via the network 106.

The real estate recommendation system 102, upon receipt of data indicative of the desired features, accesses the storage medium 104 to determine one or more matching properties (including first property 103 as well as other properties (not shown)) that have the desired features or have features similar to the desired features. The real estate recommendation system 102 then provides the matching properties for display on the first electronic device 108. The buyer's team member 109 may select one or more of the matching properties to obtain additional information about different matching properties, compare different matching properties, send notifications regarding the matching properties to other buyer's team members, and schedule appointments to view one or more of the matching properties.

In the embodiment of FIG. 1, where the first property 103 is a matching property, the real estate recommendation system 102 determines that the second electronic device 110 is operated by the listing team member 111, who is a member of a listing team that listed the first property 103. The real estate recommendation system 102 then transmits a notification to the second electronic device 110 regarding the feedback from the buyer's team member 109. In some embodiments, the notification provides the listing team member 111 with feedback from the buyer's team member 109 and the contact information of the buyer's team member 109.

As described herein, certain features of the application running on the first electronic device 108 are locked until the buyer's team member 109 is within a proximity of the first property 103 to prevent the buyer's team member 109 from providing feedback on the first property 103 without first viewing the first property 103. In some embodiments, the first electronic device 108 utilizes geolocation features (such as, but not limited to the Global Positioning System “GPS,” the Global Navigation Satellite System “GNSS,” the Beidou Navigation Satellite System (“BDS,” or another navigation system, collectively “navigation system”) to determine the current location of the buyer's team member 109. In such embodiments, the first electronic device 108 determines whether to display certain user interfaces of the application based on the current location of the buyer's team member 109. For example, the first electronic device 108, upon determining that the buyer's team member 109 is within the threshold distance from the first property 103, displays a user interface that the buyer's team member interacts with to initiate a tour of the first property 103. In some embodiments, the first electronic device 108, in response to determining that the current location of the buyer's team member 109 is within the threshold distance of the first property 103, shares certain privileged information (such as the approximate utilities cost, existence of damages to the first property, or other information that the listing team member 111 may not want to share with the general public) about the first property with the buyer's team member 109.

In some embodiments, the first electronic device 108, in response to determining that the user is within the threshold distance of the first property 103, dynamically initiates the tour and provides the tour for display on certain user interfaces of the application. In further embodiments, the first electronic device 108 is also operable to determine the position of the buyer's team member 109 within an area of the first property 103 (such as in the master bedroom, in the master bathroom, in the kitchen, or another area). In one of such embodiments, the first electronic device 108 is further operable to modify certain user interfaces of the application to display features of the area of the first property 103 proximate to the current position of the buyer's team member 109. For example, features in a walkway (such as a vanity, a bench and a closet proximate the walkway) are initially displayed on the user interface of the application when the buyer's team member 109 first enters the first property 103. As the buyer's team member 109 enters the master bedroom, the user interface of the application is dynamically updated to display features of the master bedroom (such as a bed, a dresser, wall decorations, wall color). As the buyer's team member 109 leaves the master bedroom and enters a new area of the first property 103, the user interface of the application is dynamically updated to display features of the current area of the first property 103. In some embodiments, the user interface of the application is also updated to dynamically highlight certain features proximate the current position of the buyer's team member 109. Continuing with the previous example, as the buyer's team member 109 steps into the master bedroom, the user interface also displays an image of the hardwood flooring of the master bedroom together with a description that the hardwood flooring has been recently added to the master bedroom, the cost of the addition, the added value to the first property 103, as well as other relevant information highlighting the hardwood flooring feature.

In some embodiments, the real estate recommendation system 102, in response to receiving feedback from the buyer's team member 109 regarding a feature of the first property 103, determines the current position of the buyer's team member 109, and assigns the position of the feature to a location proximate the current position of the buyer's team member 109. For example, the real estate recommendation system 102, in response to receiving feedback from the buyer's team member 109 regarding solid oak flooring, determines that the buyer's team member 109 is in the master bedroom. The real estate recommendation system 102 then determines that the master bedroom has solid oak flooring. In such embodiments, the real estate recommendation system 102 is operable to auto-populate the first property 103 with different features based geo-locating features commented by different buyer's team members (or captured in feedback) while such members tour the first property 103. In some embodiments, where the buyer's team member 109 has recently visited the first property 103, certain features of the application remain unlocked for a period of time to allow the buyer's team member 109 to access these features and to provide feedback within the threshold period of time. For example, certain feedback features of the application that allow the buyer's team member 109 to provide feedback on the first property 103 (or features of the property) are unlocked if the buyer's team member 109 is within a proximity of the first property 103 or if the buyer's team member 109 was within a proximity of the first property 103 within the threshold period of time. The application of the first electronic device 108 then transmits the feedback from the buyer's team member 109 to the real estate recommendation system 102.

The real estate recommendation system 102, upon receipt of the feedback, provides the feedback to electronic devices of other members of the buyer's team and members of other buyer's teams. In some embodiments, the real estate recommendation system 102 is operable to dynamically assess the approximate market value and the current state of certain features of the first property 103. In other embodiments, the real estate recommendation system 102 is operable to determine the market value and the current state of certain features of the first property 103 based on feedback from buyer's team members. In such embodiments, the real estate recommendation system 102 generates a highlight of the first property 103 based on such assessments, and provides the highlight of the first property 103 to the buyer's team member 109, other members of the buyer's team, as well as other members of other buyer's teams. For example, the real estate recommendation system 102, in response to determining the first property 103 is listed at $50 per square foot less other listed properties within a geographic range, determines that the first property 103 has an attractive price relative to the other proprieties, and generates a recommendation that the first property 103 is “priced to sell.” Continuing with the foregoing example, where the real estate recommendation system 102 determines that features of the first property 103 are outdated relative to other higher priced properties located within the geographic region, the real estate recommendation system 102 generates a recommendation that the first property 103 is a “fixer-upper's dream,” or is a “hidden gem.” In some embodiments, the real estate recommendation system 102 upon receipt of the feedback, provides the feedback to electronic devices of members of the listing team (including the second electronic device 110). In some embodiments, the real estate recommendation system 102 does not provide any feedback to the second electronic device 110 unless the buyer's team member 109 has consented to sharing the feedback with members of the listing team, such as the listing team member 111. In such embodiments, the real estate recommendation system 102 only provides preapproved feedback to the second electronic device 110.

The real estate recommendation system 102 analyzes the feedback from the buyer's team member 109 to gauge the buyer's team member's assessment of the first property 103. For example, the real estate recommendation system 102 is operable to utilize a text recognition application to analyze feedback written by the buyer's team member 109 regarding the kitchen of the first property 103 to determine whether the buyer's team member 109 likes or dislikes the kitchen, features of the kitchen (such as, the size of the kitchen, the condition of the kitchen, the conditions of appliances in the kitchen, the layout of the kitchen, as well as other aspects of the kitchen) the buyer's team member 109 likes or dislikes, the buyer's team member's overall assessment of the first property 103, whether the buyer's team member 109 would recommend purchasing the first property 103, as well as other assessments made the buyer's team member 109. In some embodiments, the real estate recommendation system 102 is operable to utilize other types of recognition technology to assess whether the buyer's team member likes or dislikes the kitchen or other features of the first property 103. Examples of such recognition technologies include, but are not limited to speech recognition technologies, image recognition technologies, and gesture recognition technologies that are operable to analyze the buyer's team member's speech, facial expressions, and motions to determine the buyer's team member's assessment of the first property 103.

In some embodiments, the real estate recommendation system 102 provides recommendations that address some or all of the feedback to members of the listing team (such as the listing team member 111). Continuing with the foregoing example, where the feedback from the buyer's team member 109 includes a note that the kitchen is too dark, the real estate recommendation system 102 generates multiple recommendations (such as, but not limited to painting the kitchen in a lighter color, painting the cabinetry in a lighter color, adding lighting fixtures to the kitchen, expanding or adding additional windows, and reducing the listing price of the first property 103) to address the feedback. The real estate recommendation system 102 then provides the recommendations to the second electronic device 110. In some embodiments, the real estate recommendation system 102, upon generating recommendations that address the feedback, determines which third-party providers provide goods and services that address the feedback. Continuing with the foregoing example, where the third-party provider 113 is a painter, the real estate recommendation system 102 obtains the contact information of the third-party provider 113, and transmits the recommendation to paint the kitchen along with the contact information of the third-party provider 113 to the third electronic device 112 together with a general description of the paint job.

In some embodiments, the real estate recommendation system 102 dynamically connects the listing team member 111 or a buyer team member 109 with multiple third-party providers (such as electricians, plumbers, masons, as well as other individuals or entities) that provide goods and services to alleviate or address buyer's team member's concerns about the kitchen of the first property 103. In one of such embodiments, the real estate recommendation system 102 provides different recommendations to different third-party providers (such as providing a recommendation to an electrician to add lighting fixtures, providing a recommendation to a mason to add additional windows, and providing the recommendation to the third party provider 113 to paint the kitchen). The third-party providers may review the recommendations, determine a cost estimate associated with addressing the feedback, and contact the listing team member 111 regarding the suggested improvement. Continuing with the foregoing example, where the real estate recommendation system 102 transmits the recommendation to paint the kitchen to the third electronic device 112, an application running on the third electronic device 112 provides an interface to display the recommendation to paint the kitchen together with available information about the kitchen. The third-party provider 113 accesses the application to review the recommendation and the information about the kitchen. In some embodiments, where the third-party provider 113 provides a cost estimate associated with painting the kitchen, the real estate recommendation system 102 also provide the cost estimate to the second electronic device 110. In some embodiments, the real estate recommendation system 102 connects the listing team member 111 with the third-party provider 113 so the parties may schedule a time to paint the kitchen, discuss the cost estimate, and communicate with each other.

In some embodiments, the real estate recommendation system 102, upon analyzing the feedback from the buyer's team member 109, searches for other matching properties within the geographic region that match or satisfy the feedback from the buyer's team member 109. For example, the real estate recommendation system 102, upon determining that the buyer's team member 109 prefers a bigger kitchen, searches the storage medium 104 for similar properties within the geographic region that have kitchens that are bigger than the kitchen of the first property 103. The real estate recommendation system 102 then provides matching properties that have “bigger kitchens” for display on the first electronic device 108. In some embodiments, the real estate recommendation system 102 also contacts other listing team members who listed the matching properties. In one of such embodiments, the real estate recommendation system 102 provides contact information of the buyer's team member 109 to the other listing team members. In such embodiments, the other listing team members may contact the buyer's listing member 109 to provide the buyer's listing member 109 with additional information about the their respective properties, and to set up times to view their respective properties.

The network 106 can include, for example, any one or more of a cellular network, a satellite network, a personal area network (PAN), a local area network (LAN), a wide area network (WAN), a broadband network (BBN), a RFID network, a Bluetooth network, a device to device network, the Internet, and the like. Further, the network 106 can include, but is not limited to, any one or more of the following network topologies, including a bus network, a star network, a ring network, a mesh network, a star-bus network, tree or hierarchical network, or similar network architecture. The network 106 may be implemented using different protocols of the internet protocol suite such as TCP/IP. The network 106 includes one or more interfaces for data transfer. In some embodiments, the network 106 includes a wired or wireless networking device (not shown) operable to facilitate one or more types of wired and wireless communication between the real estate recommendation system 102, the first electronic device 108, the second electronic device 110, and the third electronic device 112, as well as other electronic devices (not shown) communicatively connected to the network 106. Examples of the networking device include, but are not limited to, wired and wireless routers, wired and wireless modems, access points, as well as other types of suitable networking devices described herein. Examples of wired and wireless communication include, Ethernet, WiFi, Cellular, LTE, GPS, Bluetooth, RFID, as well as other types of communication modes described herein.

Although FIG. 1 illustrates three electronic devices 108, 110, and 112 operated by a buyer's team member 109, a listing team member 111, and a third-party provider 113, respectively, additional electronic devices operated by other buyer's team members, listing team members, or third-party providers may also be communicatively connected to the real estate recommendation system 102 via the network 106. In such embodiments, the real estate recommendation system 102 is communicatively connected to each of the additional electronic devices and is operable to simultaneously perform operations described herein to match buyer's team members, listing team members, and third-party providers, and to facilitate real estate transactions between the parties. In the embodiment of FIG. 1, different copies of an application running on the first, second, and third electronic devices 108, 110, and 112 provide user interfaces for the buyer's team member 109, the listing team member 111, and the third-party provider 113 to interact with to contact each other and to connect to the real estate recommendation system 102. In other embodiments, the user interfaces described herein are provided for display by different applications running on the first, second, and third electronic devices 108, 110, and 112.

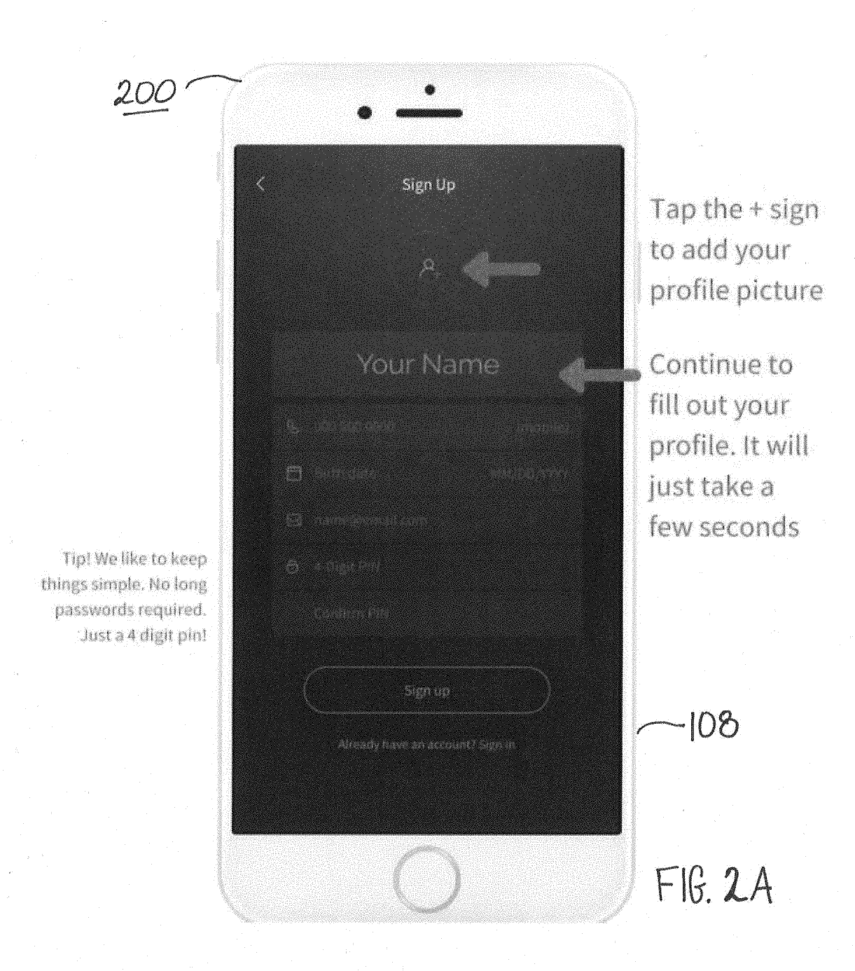

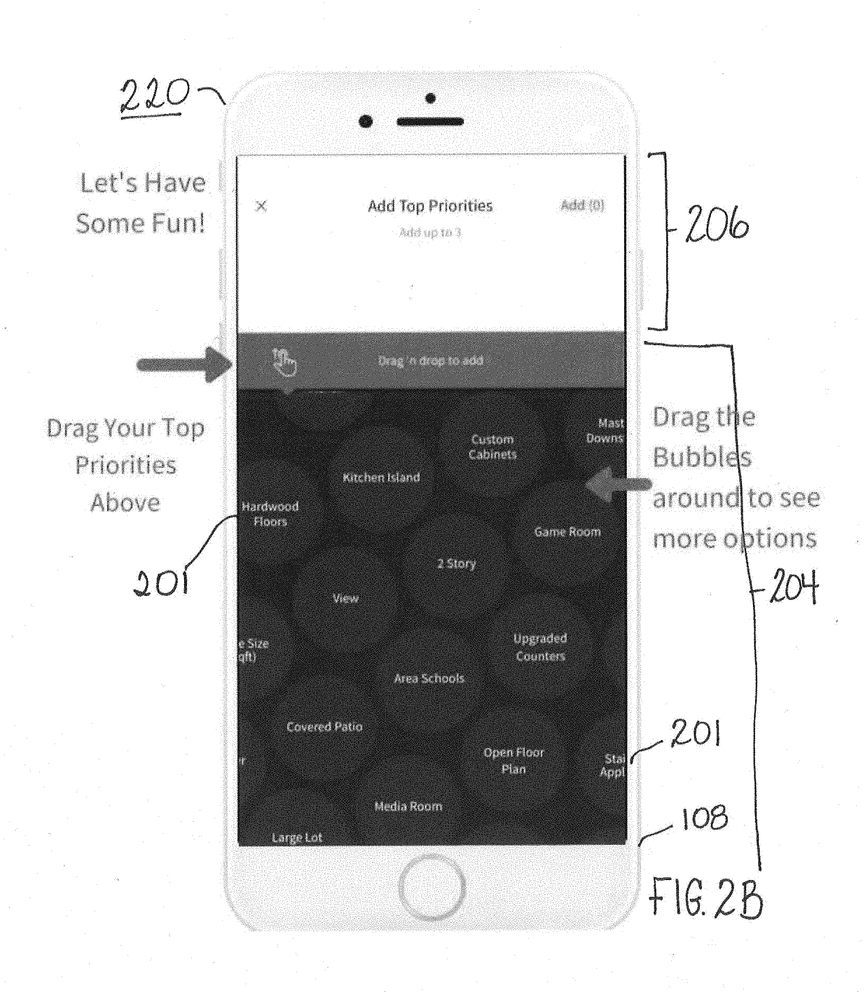

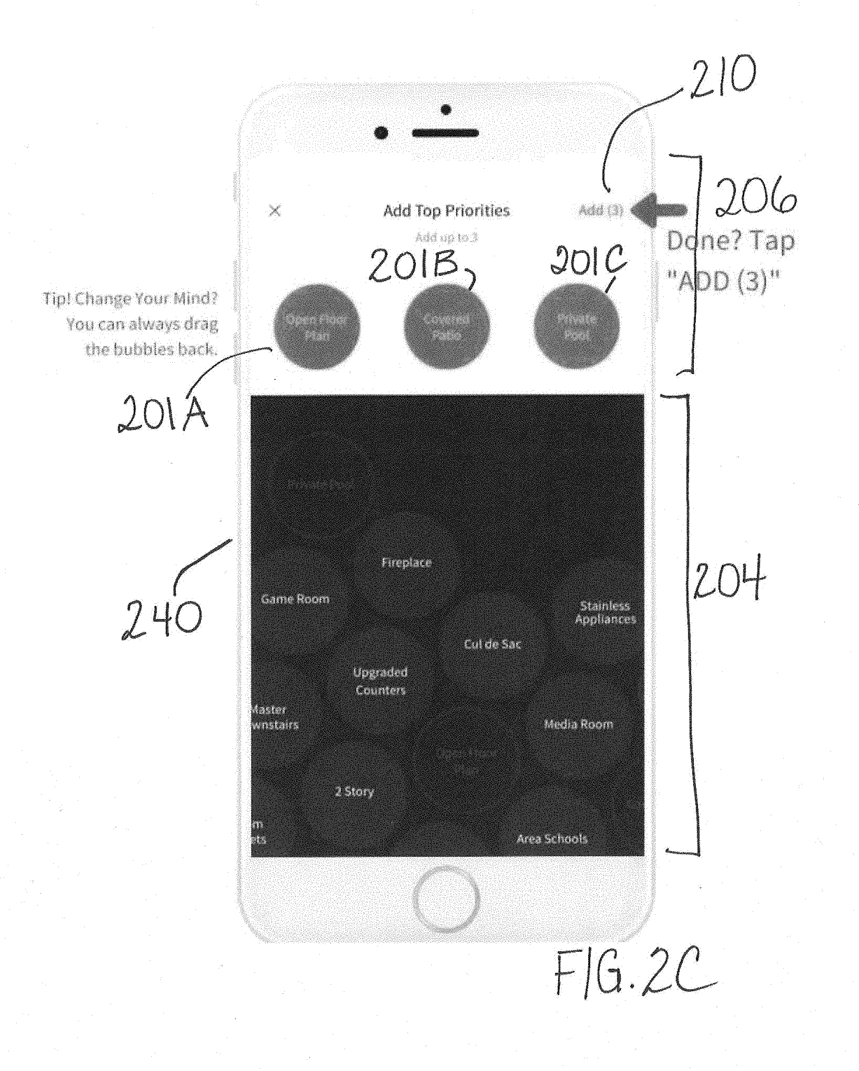

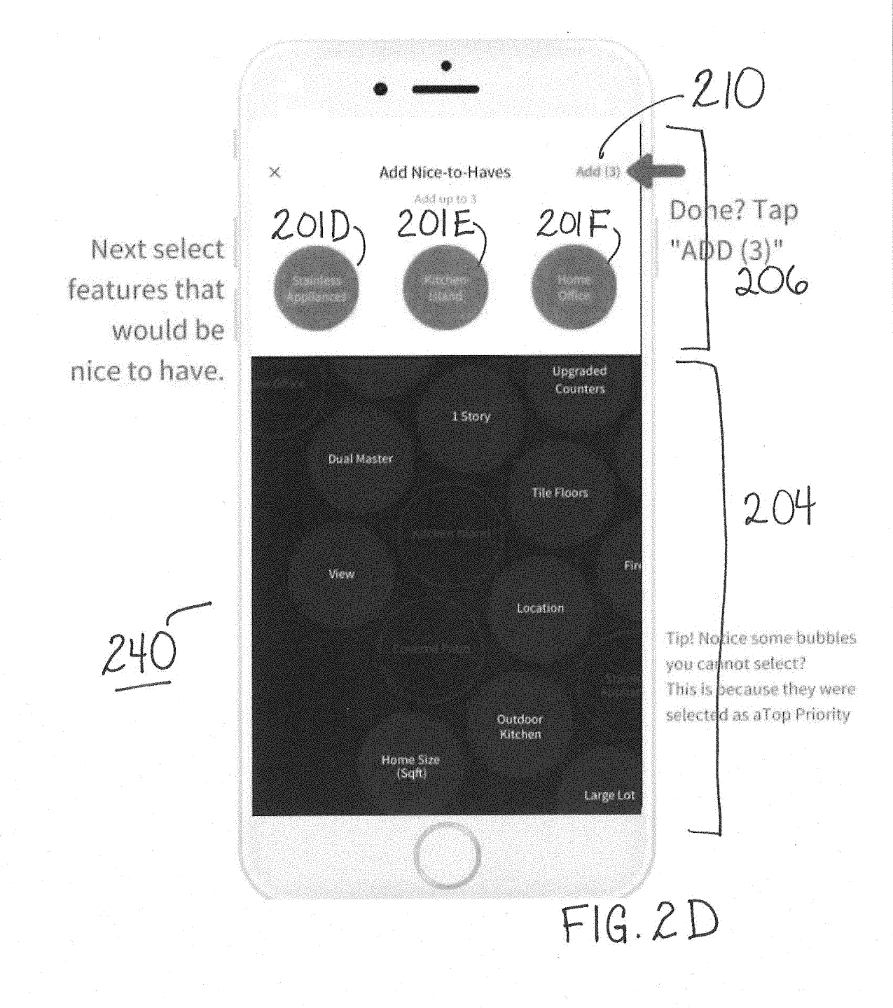

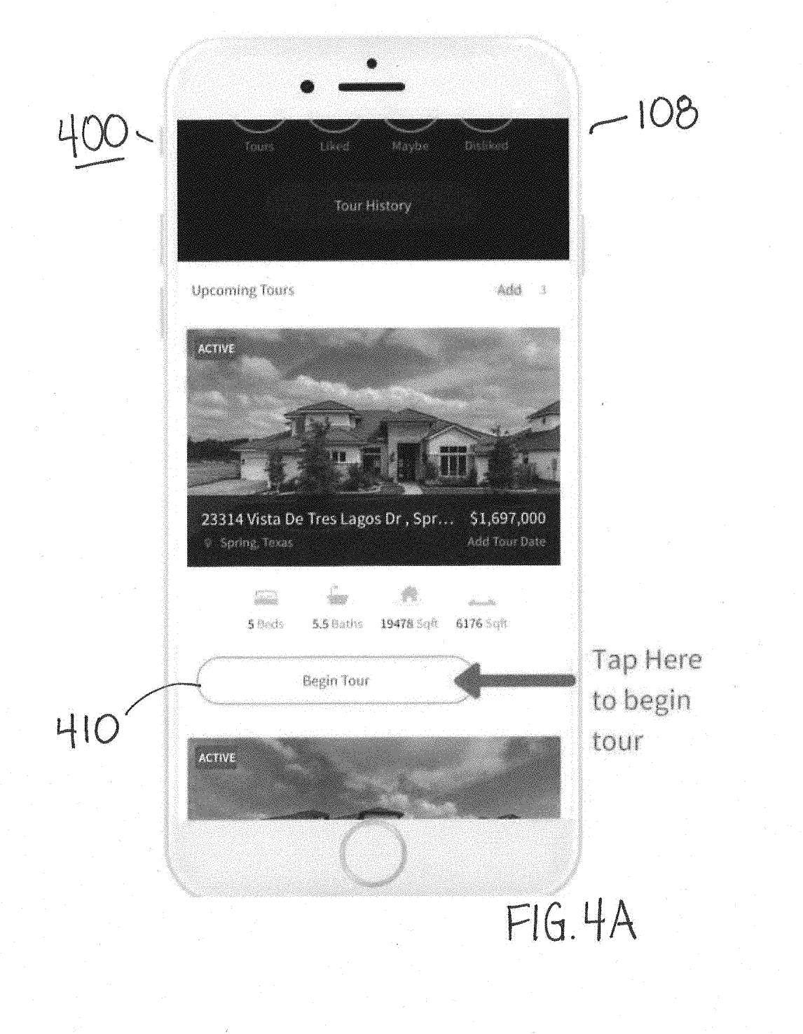

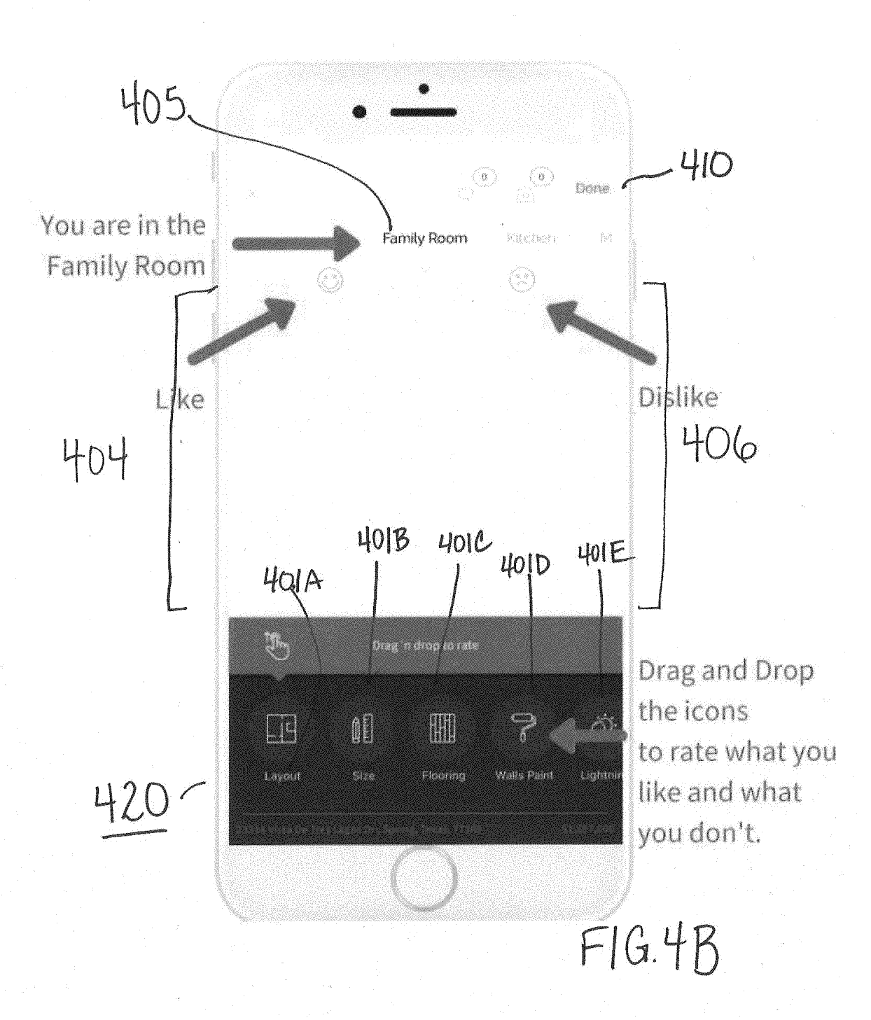

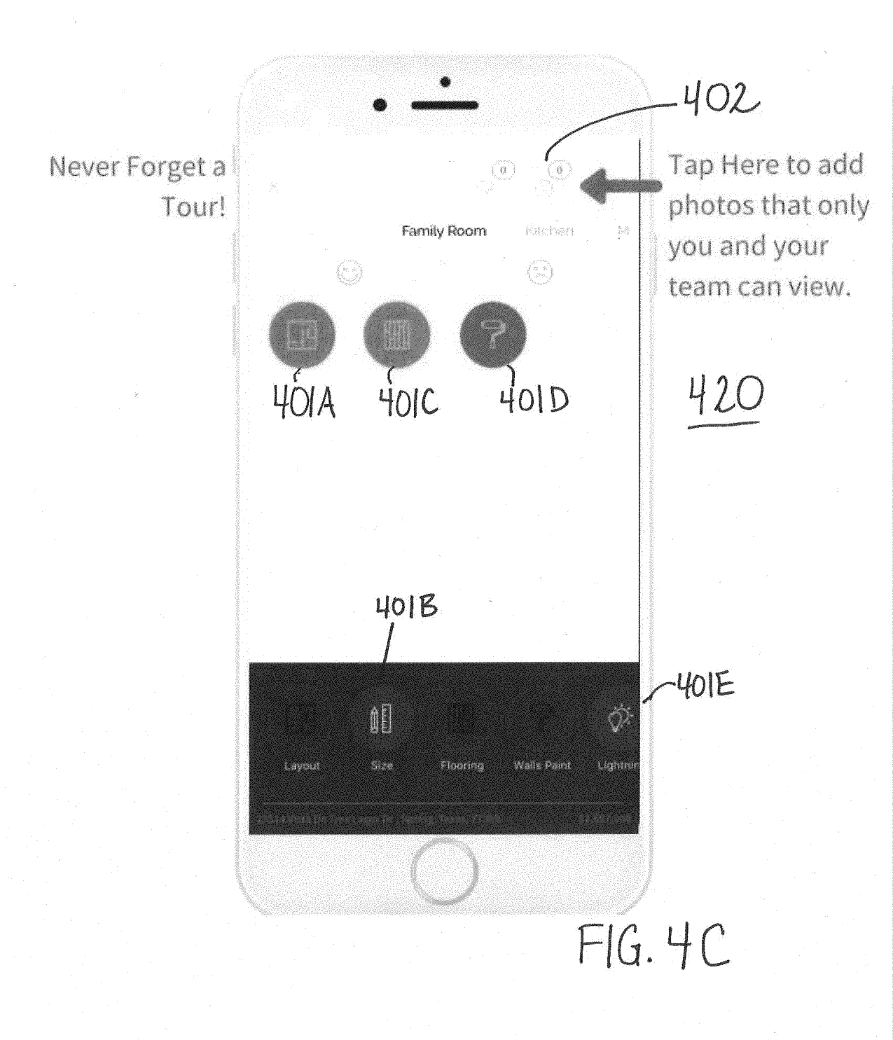

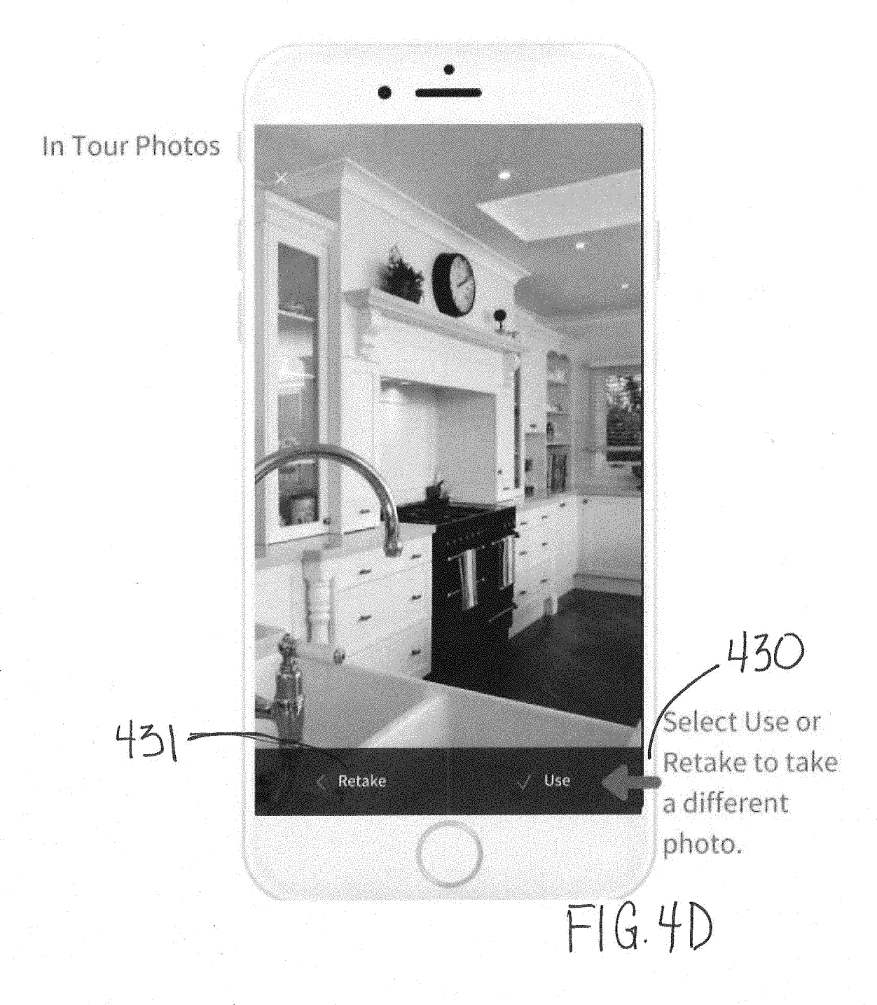

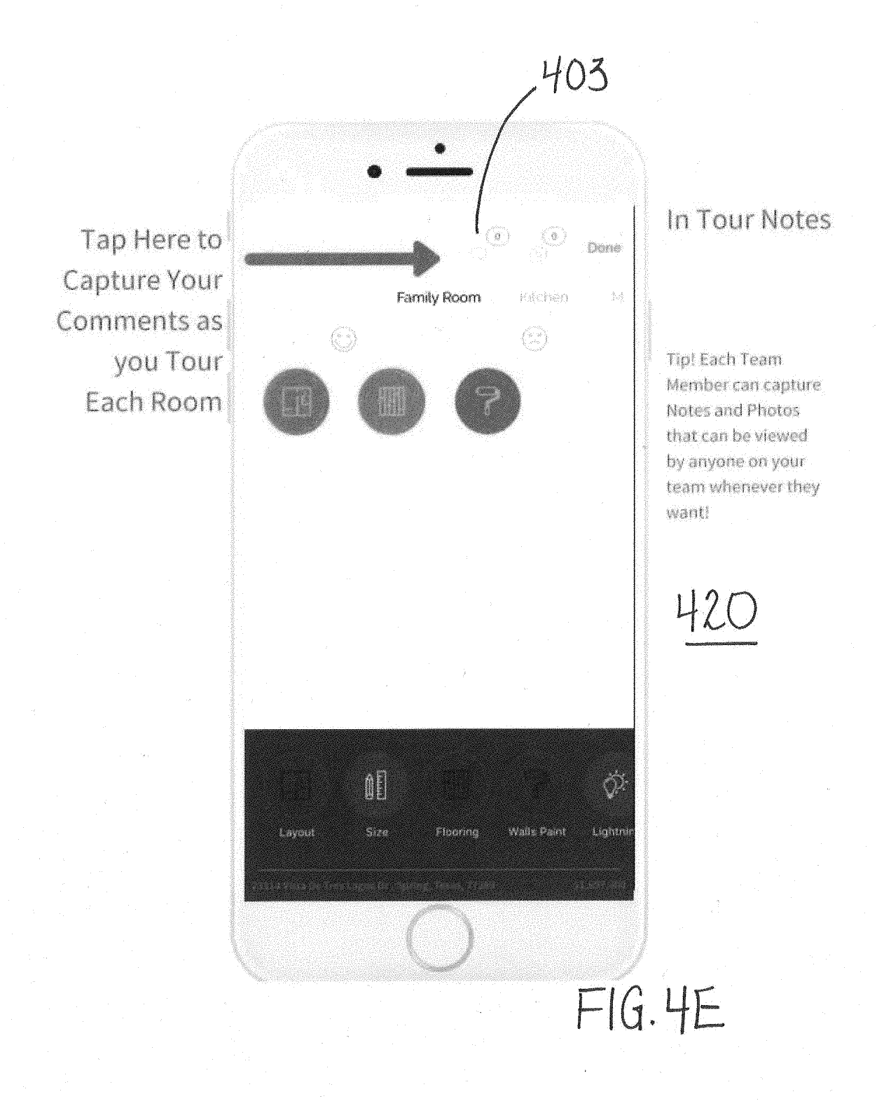

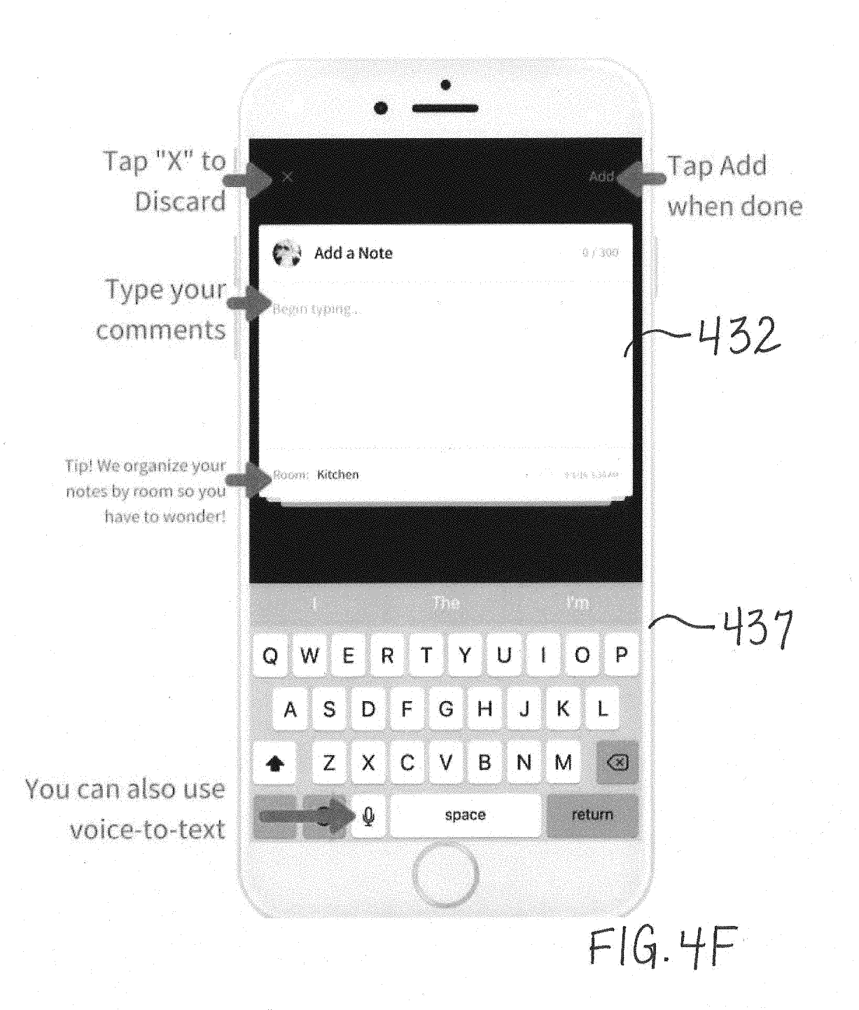

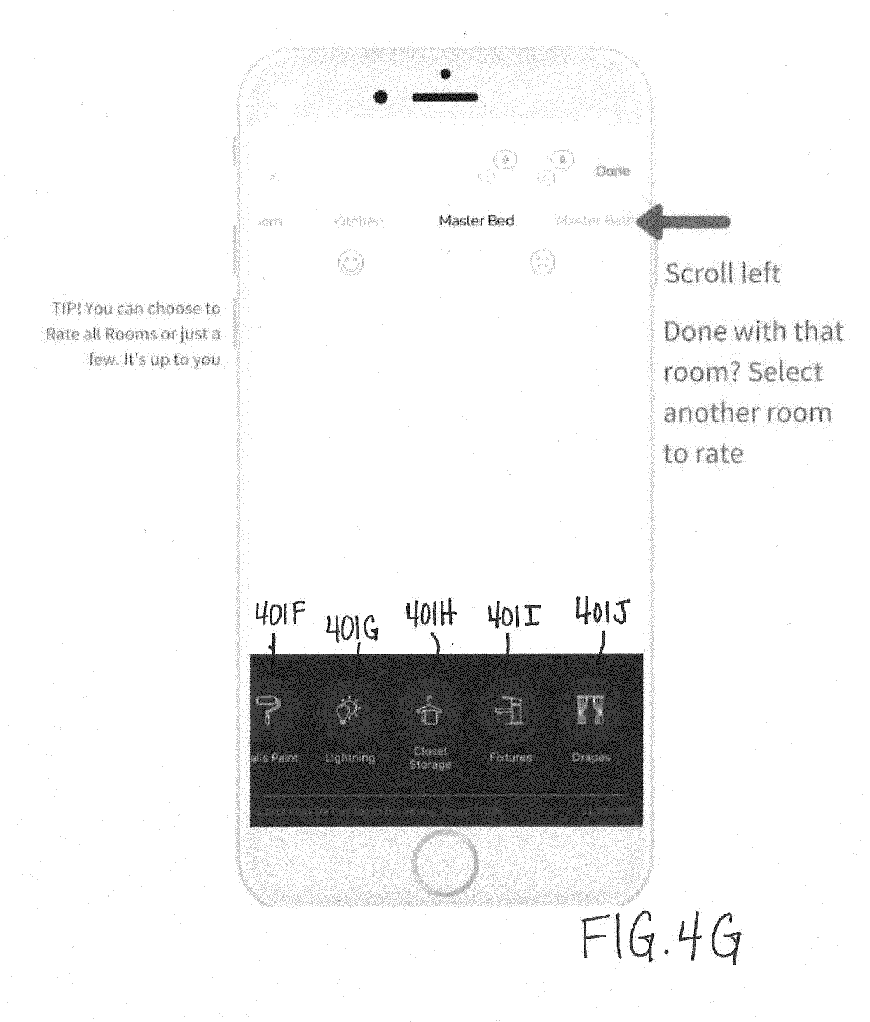

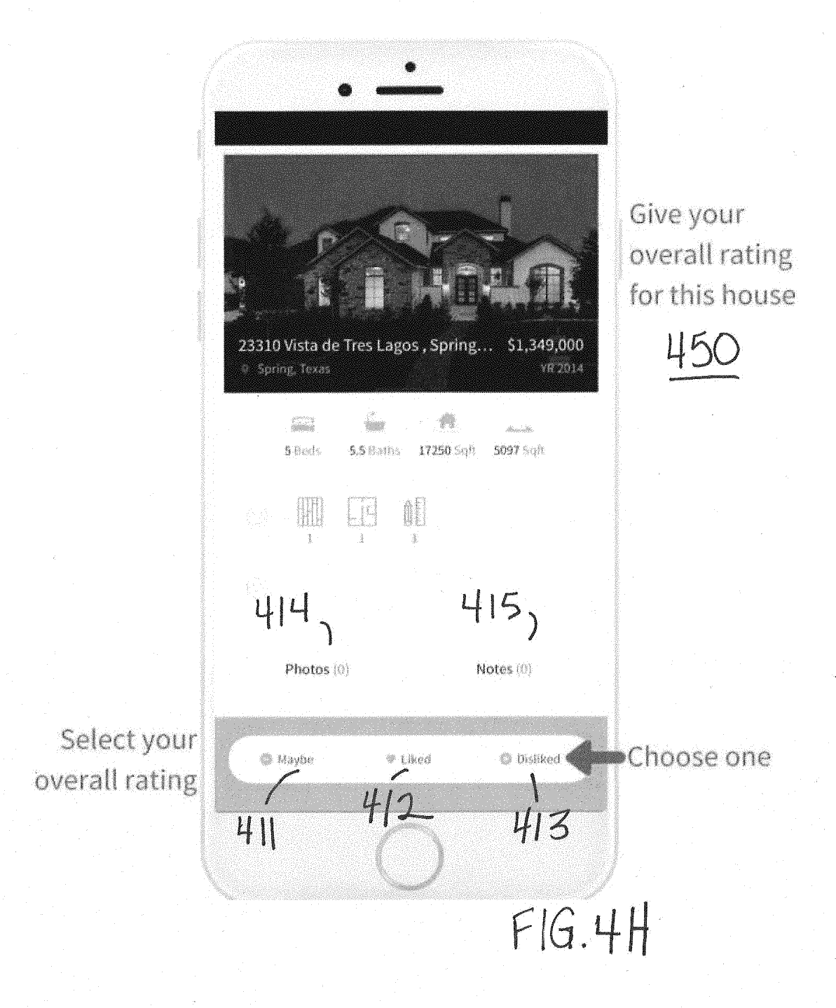

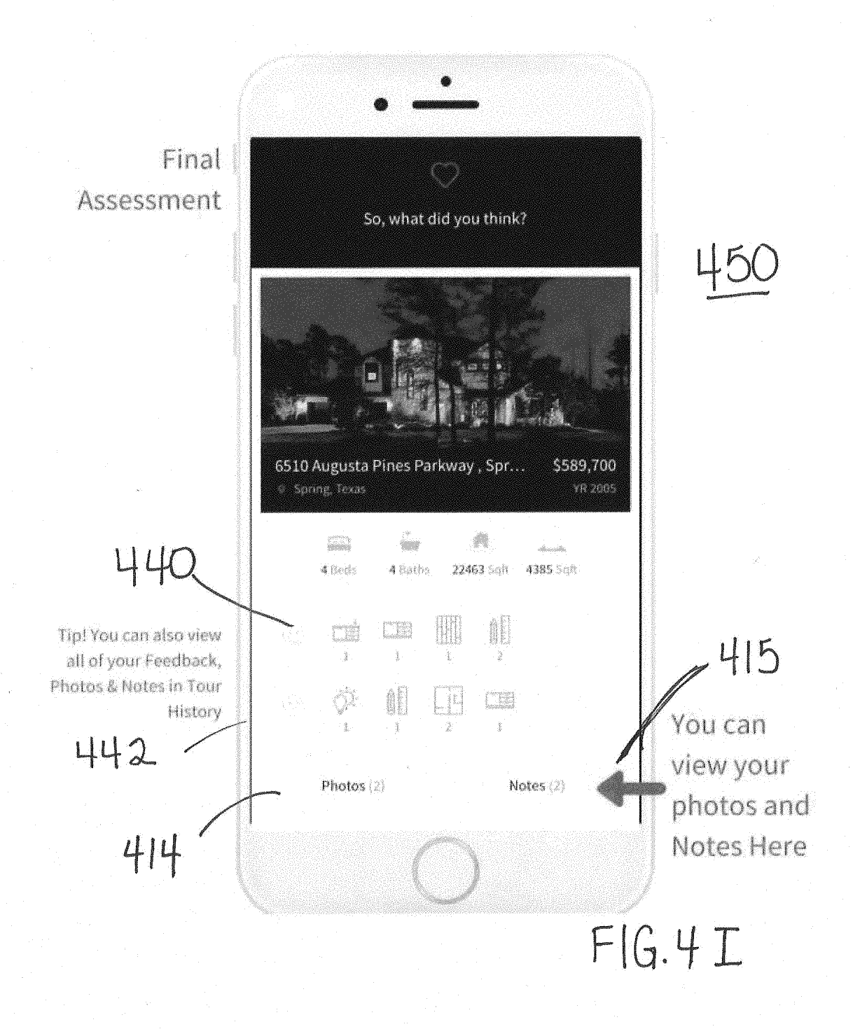

The foregoing paragraphs describe various operations performed by the real estate recommendation system 102. As described herein, the real estate recommendation system 102 provides data indicative of properties, feedback, recommendations, contact information, as well as other data related to the properties to the electronic devices of buyer's team members, listing team members, and third-party providers to facilitate real estate transactions between the parties. FIGS. 2A-2D illustrate example user interfaces a buyer's team member (such as the buyer's team member 109) interacts with to select one or more desired features of a property in accordance with one embodiment. As shown in FIG. 2A, user interface 200 of an application running on the first electronic device 108 is displayed on the first electronic device 108. The user interface 200 is a registration user interface the buyer's team member 109 interacts with to register with the real estate recommendation system 102. As shown in FIG. 2A, the user interface 200 includes several input fields the buyer's team member 109 interacts with to provide identification information of the buyer's team member 109. Once the buyer's team member 109 has registered with the real estate recommendation system 102, additional user interfaces are provided for display on the first electronic device 108. The buyer's team member 109 interacts with the user interfaces to select desired properties and to provide feedback on the desired properties. Examples of these user interfaces are illustrated in at least FIGS. 2B-2D and 4A-4I.

As shown in FIG. 2B, a user interface 220 of the application is displayed on the first electronic device 108. The user interface 220 contains a first region 204 and a second region 206. As shown in FIG. 2B, multiple affordances 201, each associated with a feature of a property (such as the first property 103) are displayed in the first region 204 of the user interface 220. As depicted in FIG. 2B, the affordances 201 have bubble shapes. In other embodiments, the affordances 201 may have different shapes (such as squares, rectangles, triangles, circles, as well as other type of shapes) and sizes. The buyer's team member 109 moves different affordances associated with different desired features from the first region 204 to the second region 206 to select features that the buyer's team member 109 considers to be “top priorities.” As defined herein, a “top priority” feature is a feature that the buyer's team member 109 requires in order to consider the property. As shown in FIG. 2C, first, second, and third affordances 201A, 201B, and 201C are associated with “open floor plans,” “covered patio,” and “private pool” features, respectively. The first, second and third affordances 201A, 201B, and 201C have been moved to the second region 206. Once the buyer's team member 109 selects all of the affordances 201 that represent top priorities, the buyer's team member 109 interacts with affordance 210 to confirm the selection of the first, second, and third affordances 201A, 201B, and 201C.

As shown in FIG. 2D, a user interface 240 of the application is displayed on the first electronic device 108. The user interface 240, similar to the user interface 220, is an interface, the buyer's team member 109 interacts with to select “preferred features.” As defined herein, a preferred feature is a feature that the buyer's team member 109 would like a desired property to include. However, the buyer's team member 109 may consider a property even if the property does not include the preferred feature. The buyer's team member 109 selects “preferred features” by dragging affordances from the first region 204 to the second region 206. As depicted in FIG. 2D, fourth, fifth, and sixth affordances 201D, 201E, and 201F are associated with “stainless appliances,” “kitchen island,” and “home office” features, respectively. Moreover, the fourth, fifth, and sixth affordances 201D, 201E, and 201F have been moved from the first region 204 to the second region 206. The buyer's team member 109 may perform other gestures to move other affordances to the second region 206 to select additional preferred features, or move some or all of the affordances in the second region 206 back to the first region 204 to remove certain preferred features. Certain affordances that are displayed in the first region 204 are locked in the first region 204. For example, where the buyer's team member 109 has selected certain features as top priorities, affordances associated with these features cannot be moved to the second region 206 (to indicate that the features are also preferred features) unless the features are no longer selected as top priorities. Once the buyer's team member 109 selects all of the affordances 201 that are associated with preferred features, the buyer's team member 109 interacts with the affordance 210 to confirm the selection of the preferred features.

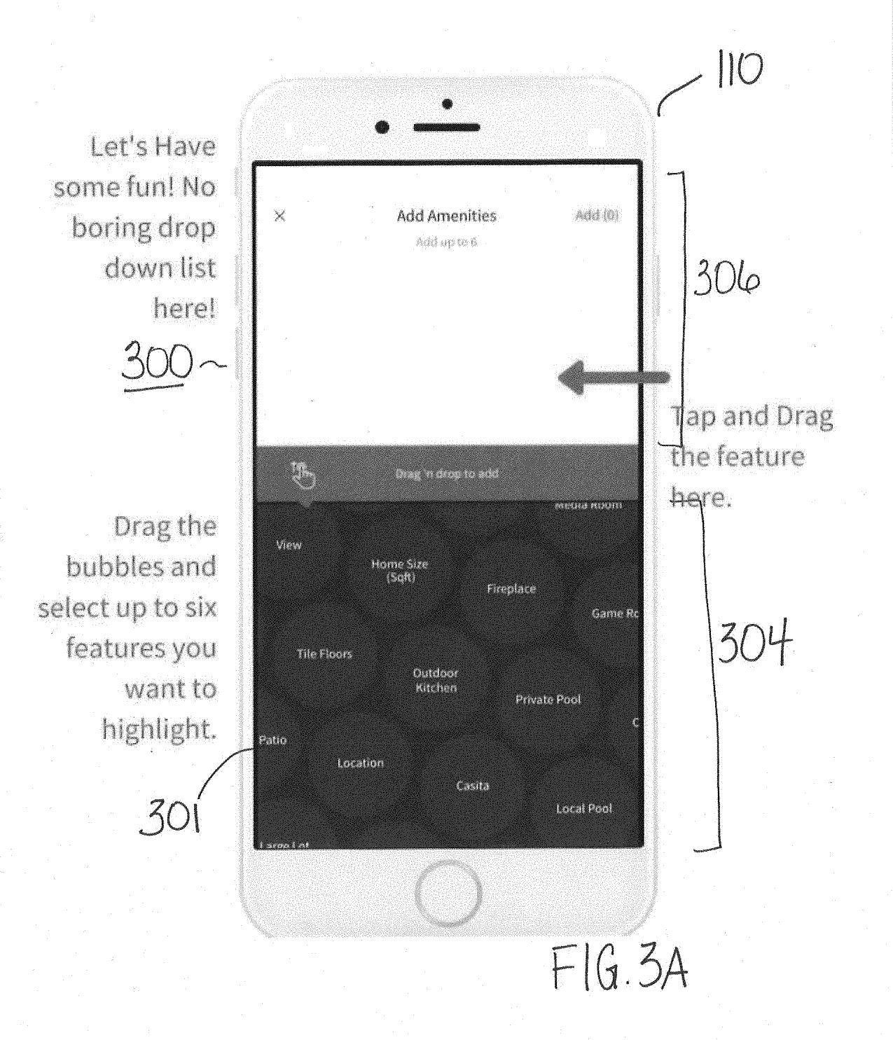

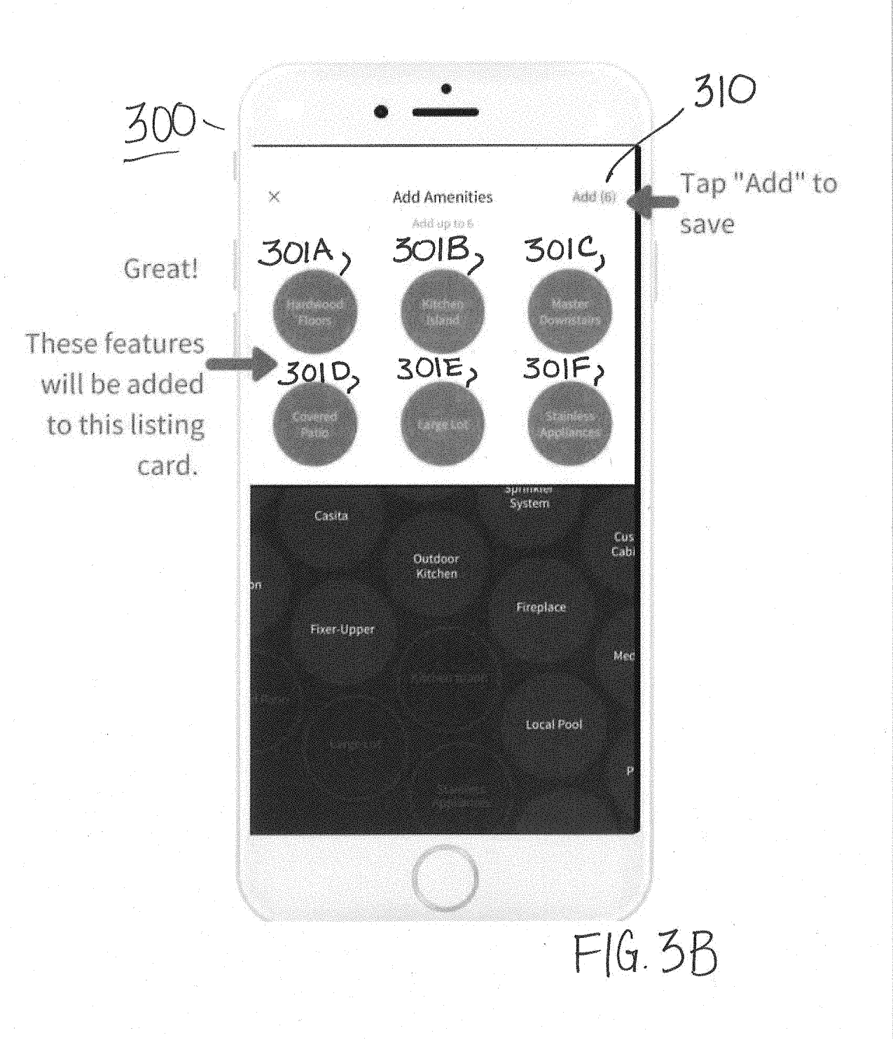

FIGS. 3A and 3B illustrate example user interfaces a listing team member, such as the listing team member 111 interacts with to select one or more features of a property to be listed (or currently listed) by the listing team member 111 in accordance with one embodiment. As shown in FIG. 3A, a user interface 300 of an application running on the second electronic device 110 is displayed on the second electronic device 110. The user interface 300 contains a first region 304 and a second region 306. As shown in FIG. 3A, multiple affordances 301, each associated with a feature of a property (such as the first property 103) listed by the listing team member 111 are displayed in the first region 304 of the user interface 300. The listing team member 111 moves different affordances that are associated with different features of the property from the first region 304 to the second region 306 to add features of the property. As shown in FIG. 3B, first, second, third, fourth, fifth, and sixth affordances 301A-301F, are associated with “hardwood floors,” “kitchen island,” “master downstairs,” covered patio,” “large lot,” and “stainless appliances,” features respectively, and have been moved to the second region 306. The listing team member 111 may perform a variety of gestures to move additional features to the second region 306 to indicate that the property contains the additional features. Once the listing team member 111 has selected all of the affordances 301 that are associated with features of the property, the listing team member 111 interacts with affordance 310 to confirm the selection of the first, second, third, fourth, fifth, and sixth affordances 301A-301F. In some embodiments, the real estate recommendation system 102 creates a new property listing with the selected features or updates an existing property listing with the selected features in response to receiving a confirmation of the selected features from the application.

FIGS. 4A-4I illustrate example user interfaces the buyer's team member 109 interacts with to provide feedback on the first property 103 in accordance with one embodiment. As shown in FIG. 4A, a user interface 400 of the application is displayed on the first electronic device 108. The user interface 400 is a user interface the buyer's team member 109 interacts with to select a property, such as the first property 103 to tour. More particularly, the buyer's team member 109 interacts with affordance 410 to begin a tour of the first property 103. As shown in FIG. 4B, the application, in response to detecting a user interaction with the affordance 410, provides user interface 420 for display on the first electronic device 108. The user interface 420 contains an identifier 405 that identifies an area of the first property 103 the buyer's team member 109 is viewing. In the depicted embodiments, of FIG. 4A, the area the buyer's team member 109 is viewing is the “family room” of the first property 103. The user interface 420 also contains a first region 404 and a second region 406. The user interface 420 also displays different affordances, such as affordances 401A-401E, which are associated with different features of the family room. As shown in FIG. 4B, first, second, third, fourth, and fifth affordances 401A-401E, are associated with “layout,” “size,” “flooring,” “wall paint,” and “lighting” features of the family room, respectively, and are displayed in the user interface 420. The buyer's team member 109 may move some of the affordances 401A-401E to the first region 404 to indicate that the buyer's team member likes the corresponding features, and move other affordances to the second region 406 to indicate that the buyer's team member 109 does not like the corresponding features. In some embodiments, the first region 404 and the second region 406 contain different visual representations (such as different colored backgrounds) to distinguish the respective regions. Further, the buyer's team member may interact with affordance 410 to end the tour session of the first property 103.

FIG. 4C illustrates the user interface 420, where affordances 401A and 401C are displayed in the first region 404 and affordance 401D is displayed in the second region 406. The locations of the affordances 401A and 401C indicate that the buyer's team member likes the layout of the family room and the flooring of the family room. Further, the location of the affordance 401D indicates that the buyer's team member 109 does not like the wall paint of the family room. The buyer's team member 109 may move the remaining affordances 401B and 401E to the first or the second region 404 or 406 to express whether the buyer's team member 109 likes or dislikes the size of the family and the lighting of the family room. The buyer's team member 109, in addition to indicating whether he/she likes or dislikes certain features of the family room, may also capture images of certain features of the family room. For example, the buyer's team member 109 may interact with affordance 402 to take images (or videos) of the family room or certain features of the family room.

As shown in FIG. 4D, the application, in response to determining a user interaction with the affordance 402, overlays the user interface 420 with a camera interface that displays a preview of an image to be captured by a camera component of the first electronic device 108. The buyer's team member 109 may interact with affordance 430 to take a picture of a feature of the family room or interact with affordance 431 to retake a picture of the feature.

The buyer's team member 109 may also take notes regarding certain features of the area. In the embodiment of FIG. 4E, the buyer's team member 109 interacts with affordance 403 to take notes on the features in the family room. As shown in FIG. 4F, the application, in response to determining a user interaction with the affordance 403, overlays the user interface 420 with a comments section 432 and a keyboard 437. The buyer's team member 109 may utilize the keyboard 437 to type (or dictate) feedback regarding features of the family room. When the buyer's team member 109 views a different area (such as the kitchen, the master bedroom, or another area) of the first property 103, the application is operable to provide features of the current area for display. In some embodiments, the application, in response to detecting that the buyer's team member 109 has moved to a new area of the property, updates the user interface 420 with features of the new area. In other embodiments, the buyer's team member manually adjusts the user interface (such as by performing a swiping gesture to select the new area) to select the new area the buyer's team member 109 would like to review. As shown in FIG. 4G, the user interface 420 also displays affordances 401F-401J, which are associated with different features of the new area (master bedroom) of the first property 103. The buyer's team member 109 may perform actions described in the foregoing paragraphs and illustrated in FIGS. 4B-4F to select features the buyer's team member 109 likes or dislikes, take photos of different features, and provide reviews of certain features of the master bedroom.

The buyer's team member 109, in addition to reviewing areas and features of the first property 103 (or after reviewing one or more areas or features of the first property 103), may also provide an overall review of the first property 103. As shown in FIG. 4H, a user interface 450 displays an overall review of the first property 103. The user interface 450 includes affordances 411, 412, and 413, which the buyer's team member 109 may interact with to provide an overall rating of the first property 103. As shown in FIG. 4I, the buyer's team member 109 may also interact with affordances 414 and 415 to access pictures (of different areas and features of the first property 103) taken by the buyer's team member 109 or by other members of the buyer's team and to access notes taken by the buyer's team member 109 or by other members of the buyer's team. These pictures and notes may assist the buyer's team member 109 to form an overall review of the first property 103. In some embodiments, the buyer's team member may elect to share some of all of the feedback with other members of the buyer's team, or with the members of the listing team. In such embodiments, the buyers team member 109 interacts with an affordance (not shown) to designate recipients of the feedback.

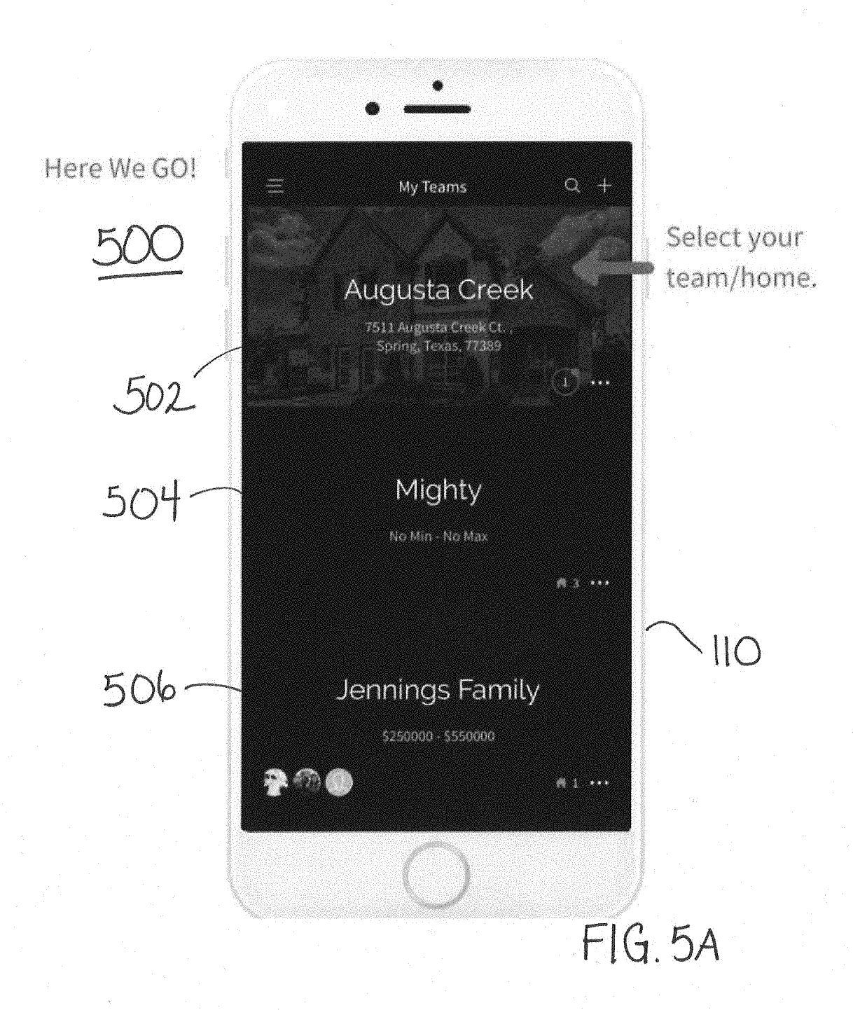

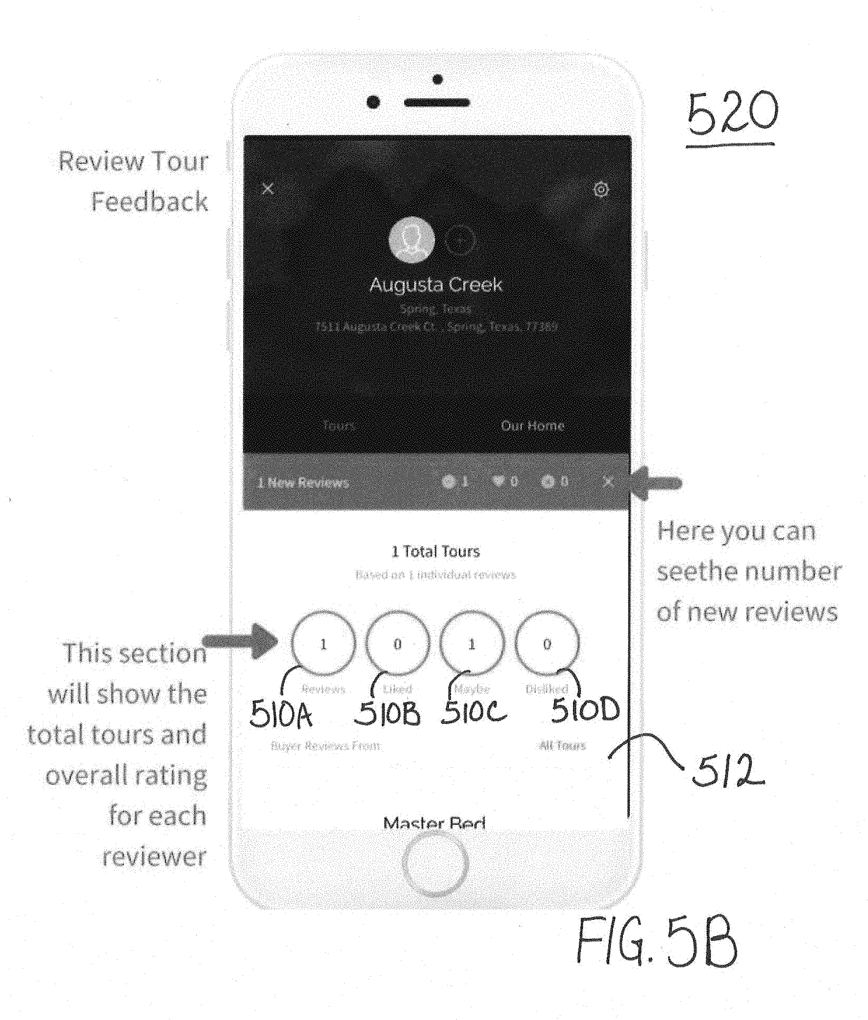

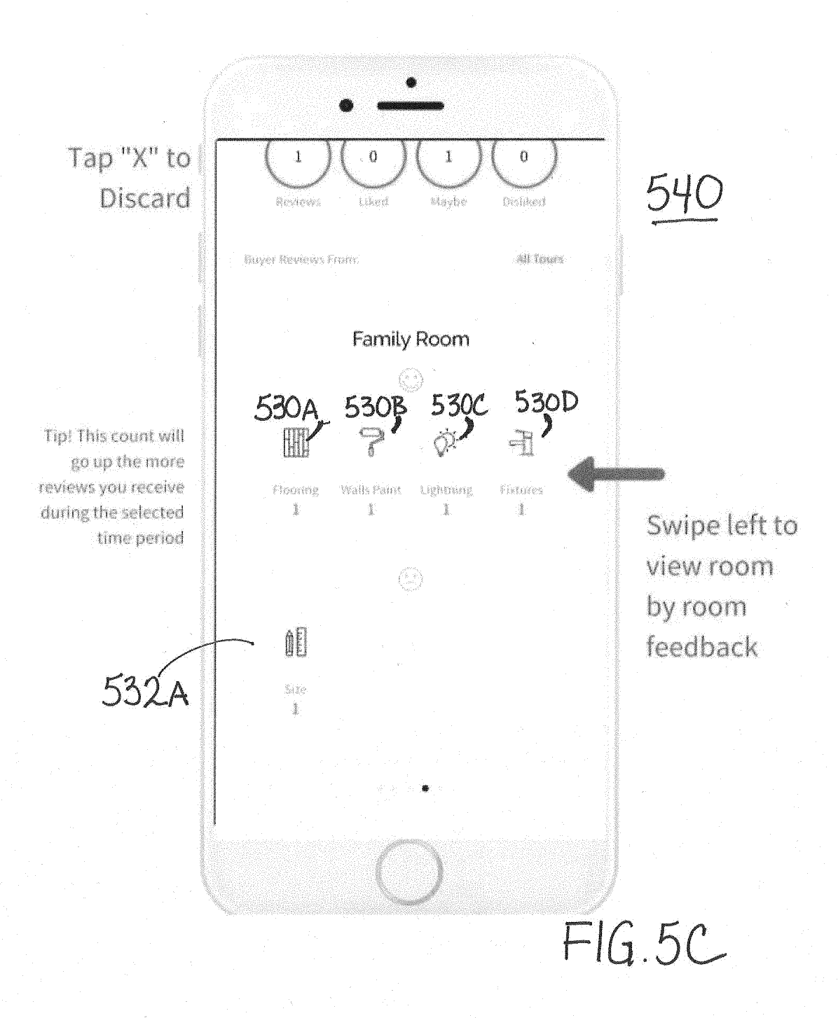

Once the buyer's team member 109 has completed a review of the first property 103, the review is transmitted to the real estate recommendation system 102. The real estate recommendation system 102 provides some or all of the reviews to the listing team member 111. FIGS. 5A-5C illustrate example user interfaces the listing team member 111 interacts with to review feedback from the buyer's team member 109. As shown in FIG. 5A, a user interface 500 of the application running on the second electronic device 110 is displayed on the second electronic device 110. The listing team member 111 interacts with the user interface 500 to obtain feedback on properties listed by the members of the listing team. For example the listing team member 111, interacts with affordance 502 to obtain reviews on the first property 103. Alternatively, the listing team member 111 may also select affordances 504 and 506 to obtain other feedback on other properties listed by members of the listing team. As shown in FIG. 5B, the application, in response to detecting a user interaction with the affordance 502, provides user interface 520 for display on the second electronic device 110. The user interface 520 contains identifiers 510A-510D, which represent the total number of feedback received from buyer's team members, as well as ratings from the buyer's team members. The user interface 520 also contains affordance 512, which the listing team member 111 may interact with to obtain feedback received within a period of time (such as within the last day, past week, past month, past three months, since the creation of the listing, or another quantifiable period of time). In some embodiments, reviews of different areas of the first property 103 and different features of the properties are also provided to the listing team member 111 to provide the listing team member 111 with granulized feedback. As shown in FIG. 5C, affordances 530A-530D and 532A are displayed at different regions of user interface 540. The affordances 530A-530D are associated with different features the buyer's team members like (as well as the total number of likes by different buyer's team members), whereas affordance 532A is associated with features the buyer's team members dislike (and the total number of dislikes by different buyer's team members). This feedback from buyer's team members as well as other types of feedback described herein help the listing team member 111 not only gauge the amount of interest in the first property 103, but also help the listing team member 111 determine how to improve the property to facilitate a transaction between the listing team member 111 and the buyer's team member 109.

The above-disclosed embodiments have been presented for purposes of illustration and to enable one of ordinary skill in the art to practice the disclosed embodiments, but are not intended to be exhaustive or limited to the forms disclosed. Many insubstantial modifications and variations will be apparent to those of ordinary skill in the art without departing from the scope and spirit of the disclosure. The scope of the claims is intended to broadly cover the disclosed embodiments and any such modification.

As used herein, the singular forms “a”, “an” and “the” are intended to include the plural forms as well, unless the context clearly indicates otherwise. It will be further understood that the terms “comprise” and/or “comprising,” when used in this specification and/or the claims, specify the presence of stated features, steps, operations, elements, and/or components, but do not preclude the presence or addition of one or more other features, steps, operations, elements, components, and/or groups thereof. In addition, the steps and components described in the above embodiments and figures are merely illustrative and do not imply that any particular step or component is a requirement of a claimed embodiment.

What is claimed is:

1. A method to facilitate a real estate transaction, comprising:
receiving a first feedback from a first electronic device of a first member of a buyer's team while the first electronic device is within a threshold distance of a property, the first feedback relating to a first feature of a plurality of features of the property;
determining, based on the first feedback, a recommendation to a listing team member belonging to a listing team that listed the property; and
providing the first feedback and the recommendation to the listing team member.

2. The method of claim 1, further comprising:
providing the first feedback to a third-party provider;
receiving, from the third-party provider, a cost estimate to address the first feedback; and
providing the cost estimate and contact information of the third-party provider to the listing team member.

3. The method of claim 1, further comprising:
receiving a second feedback from a second electronic device of a second member of the buyer's team while the second electronic device is within the threshold distance of a property, the second feedback relating to the first feature of the plurality of features of the property;
determining, based on the second feedback, the recommendation to the listing team member; and
providing the second feedback to the listing team member.

4. The method of claim 3, further comprising:
forming an aggregated feedback of the first feature based on an aggregation of the first feedback and the second feedback;
determining the recommendation based on the aggregated feedback; and
providing the aggregated feedback to the listing team member.

5. The method of claim 4, further comprising:
assigning a first value to the first feedback; and
assigning a second value to the second feedback,
wherein determining an aggregated feedback is based on a cumulative value of the first value and the second value.

6. The method of claim 1, further comprising in accordance with a determination that the first member of the buyer's team is within a threshold distance from the property, providing a request for the first feedback for display on the first electronic device.

7. The method of claim 1, further comprising:
determining, based on the first feedback, one or more alternative properties for the first member of the buyer's team; and
providing the one or more alternative properties for display on the first electronic device.

8. The method of claim 7, further comprising determining, based on one or more traits of the first member of the buyer's team, the one or more alternative properties for the first member of the buyer's team.

9. The method of claim 1, further comprising:
determining one or more advertisements of one or more third party providers; and
displaying the one or more advertisements on the first electronic device.

10. A real estate property recommendation system, comprising:
a storage medium operable to store:
contact information of a plurality of buyer's team members, listing team members, and third-party providers; and
a plurality of feedbacks generated by one or more of the plurality of buyer's team members, each feedback of the plurality of feedbacks being associated with a feature of a property listed by a listing team member of the plurality of listing team members; and
a processor operable to:
generate, based on a first feedback of the plurality of feedbacks, a recommendation that addresses the first feedback;
provide the recommendation to one or more third-party providers;
obtain, from the one or more third-party provider, at least one cost estimate to address the first feedback; and
provide the recommendation, the at least one cost estimate, and contact information of the one or more third-party providers to the listing team member.

11. The real estate property recommendation system of claim 10, wherein the processor is further operable to:
aggregate the first feedback and one or more additional feedbacks, wherein the first feedback and the one or more additional feedbacks are associated with a common feature of the property; and
generate the recommendation based on an aggregation of the first feedback and the one or more additional feedbacks.

12. The real estate property recommendation system of claim 11, wherein the processor is further operable to provide each of the one or more additional feedbacks to the one or more third-party providers.

13. The real estate property recommendation system of claim 11, wherein the processor is further operable to:
assign a value to each of the first feedback and the one or more additional feedbacks;
wherein the processor aggregates the first feedback and the one or more additional feedbacks based on a cumulative value of the assigned values.

14. The real estate property recommendation system of claim 10, wherein the processor is further operable to:
determine, based on the first feedback, one or more alternative properties for a first member of the plurality of buyer's team members, wherein the first member is associated with the first feedback; and
providing the one or more alternative properties to the first member of the plurality of buyer's team members.

15. The real estate property recommendation system of claim 14, wherein the processor is further operable to determine, based on one or more traits of the first member of the plurality of buyer's team members, the one or more alternative properties for the first member of the buyer's team.

16. A method to generate real estate recommendations, comprising:
determining a location of an electronic device;
in response to a determination that the location of the electronic device is within a threshold distance of a property, displaying a plurality of affordances on a first region of a display screen of the electronic device, each affordance being associated with a feature of the property;
detecting a first gesture from a user of the electronic device to move a first affordance of the plurality of affordances to a new location on the display screen; and
generating, based on the new location of the first affordance, a first user feedback on a first feature associated with the first affordance.

17. The method of claim 16, further comprising:
displaying a virtual representation of the property in a second region of the display screen; and
in response to detecting the first gesture:
determining one or more alternative features of the first feature; and
displaying one or more affordances that are associated with the one or more alternative features in the first region.

18. The method of claim 17, further comprising:
detecting a second gesture from the user to select one of the one or more alternative features of the first feature; and
in response to detecting the second gesture, customizing the virtual representation of the property to include a corresponding feature of the selected one of the one or more alternative features.

19. The method of claim 16, further comprising:
determining a first period of time during which the electronic device was within the threshold distance of the property; and
in response to a determination that the location of the electronic device was within a threshold distance of the property during a threshold period of time, displaying the plurality of affordances on the first region of a display screen of the electronic device.

20. The method of claim 16, further comprising in response to a determination that the location of the electronic device is not within the threshold distance of a property, withholding one or more of the plurality of affordances from being displayed on the first region of the display screen.
